(19) United States
(12) Patent Application Publication
(10) Pub. No.: US 2018/0329444 A1
(43) Pub. Date: Nov. 15, 2018

(54) OPERATING UNIT FOR A VEHICLE COMPONENT, IN PARTICULAR FOR A HEATING, VENTILATION AND/OR AIR CONDITIONING SYSTEM

(71) Applicant: BEHR-HELLA THERMOCONTROL GMBH, Stuttgart (DE)

(72) Inventor: Winfried FUST, Lippstadt (DE)

(21) Appl. No.: 15/770,315

(22) PCT Filed: Oct. 24, 2016
(86) PCT No.: PCT/EP2016/075565

§ 371 Date: Jul. 25, 2018

(30) Foreign Application Priority Data
Oct. 23, 2015 (DE) 10 2015 220 789.7

(51) Int. Cl. G05G 1/02; B60K 37/06; B60H 1/00

(52) U.S. Cl. CPC G05G 1/02; G05G 5/05; B60H 1/0065; B60K 37/06

(57) ABSTRACT

The operating unit for a vehicle component, in particular for a heating, ventilation and/or air conditioning system, is provided with a manually actuatable actuating element, a retaining device for retaining the actuating element, and a bearing device for elastically mounting the actuating element on the retaining device. The bearing device comprises at least one first leaf spring pair, including two leaf springs that are disposed on top of and spaced apart from one another and extend parallel to one another, the first ends of which that are disposed on top of one another are directly or indirectly joined to the actuating element, and the second ends of which that are disposed on top of one another are directly or indirectly joined to the retaining device. The bearing device furthermore comprises at least one second pair of leaf springs. This at least one second leaf spring pair is oriented at an angle different from 0° with respect to the at least one first leaf spring pair, and in particular perpendicularly to the at least one first leaf spring pair.

The invention relates to an operating unit for a vehicle component, wherein the vehicle component is, in particular, a heating, ventilation and/or air conditioning system. In principle, however, the operating unit can also be used to control other vehicle components, such as a radio, an infotainment device and/or a navigation device.

Operating units for vehicle components are known in a wide variety of designs. In recent years, operating units in which acoustic or tactile feedback is provided when an actuating element of the operating unit is manually actuated are increasingly taking hold. In general, the actuating element is a component that is sensitive to touch and includes multiple symbol fields for inputting a wide variety of commands.

The concept of haptic feedback when an actuation of an operating unit is identified is also referred to as “force sense, force feedback.” The actuating element that is generally depressed should have to carry out only as small a stroke as possible so as to acknowledge that contact has been made with a symbol field so as to trigger the corresponding control function. For comfort reasons, it is desirable that the entire actuating element undergoes parallel displacement, and more particularly also when the actuating element is manually depressed at the edge, for example, which is to say as far away from the center of gravity of the actuating element or the center of the operating panel thereof.

Parallel guidance on operating buttons and operating elements comprising operating panels that include multiple symbol fields are known from the prior art.

In some instances leaf spring designs are used for this purpose; however, these are able to satisfy growing expectations in terms of comfort only to a limited extent.

A reversibly depressible push button is known from DE-A-10 2014 007 988, which on both sides of a web extending perpendicularly to the operating panel and in the direction of movement is connected in an articulated manner to lever pairs, wherein the one lever pairs are, in turn, fastened in an articulated manner to fixed bearings, and the opposing lever pairs are fastened in an articulated manner to sliding bearings.

A single spring beam system on the four edge sections of a retaining element is described in DE-A-36 16 669, wherein a frame, which carries a button element, is resiliently mounted by way of the four individual spring beams.

Further button guidance designs are known from DE-A-197 57 928 and DE-A-37 11 789.

It is the object of the invention to improve the parallel guidance of depressible operating elements, and in particular such comprising operating panels that include multiple symbol fields. So achieve this object, the invention provides an operating unit for a vehicle component, and in particular for a heating, ventilation and/or air conditioning system, the operating unit being provided with:
a manually actuatable actuating element;
a retaining device for retaining the actuating element; and
a bearing device for elastically mounting the actuating element on the retaining device,
wherein the bearing device comprises at least one first leaf spring pair, including two leaf springs that are disposed on top of and spaced apart from one another and extend parallel to one another, each having a first end and a second end located opposite therefrom, wherein the first and second ends of the leaf springs are each rigidly joined to one another by a spacer element, and wherein the at least one first leaf spring pair, at the first ends of the leaf springs thereof, is directly or indirectly joined to the actuating element, and at the second ends of the leaf springs thereof, is directly or indirectly joined to the retaining device.

According to the invention, it is provided on this operating unit
that the bearing device comprises at least one second pair of leaf springs between the actuating element and the retaining device, and
that the at least one second leaf spring pair is oriented at an angle different from 0° with respect to the at least one first leaf spring pair, and in particular perpendicularly to the at least one first leaf spring pair.

In the invention, the at least one manually actuatable actuating element of the operating unit is elastically mounted on the retaining device, a bearing device is used for this purpose, which is disposed between the actuating element and the retaining device. This bearing device comprises at least one leaf spring pair. This first leaf spring pair comprises two leaf springs that extend parallel to one another and are disposed on top of and spaced apart from one another, the ends thereof being held at a distance by way of spacer elements. The one pair of leaf spring ends is directly or indirectly fixed to the actuating element, and the other pair of leaf spring ends is directly or indirectly fixed to the retaining device. Such an elastic leaf spring mounting results in a parallel displacement of the actuating element when this is depressed, taking advantage of the elasticity of the leaf springs clamped between the ends. Strictly speaking, this only applies to comparatively short strokes of a few millimeters to a few 1/10 mm. What is essential is that the direction of movement of the actuating element during depression runs substantially perpendicularly to the operating panel of the actuating element and does not change the orientation thereof in the space in the process (parallel guidance).

So as to be able to guarantee the parallel guidance and the direction of movement of the actuating element perpendicular to the operating panel essentially independently of the actuating spot on the operating panel, it is provided according to the invention that the bearing device, in addition to the at least one first leaf spring pair, comprises at least one second leaf spring pair, which is oriented at an angle different from 0° with respect to the at least one first leaf spring pair, and in particular perpendicularly thereto. This considerably improves the parallel guidance of the actuating element upon depression, and more particularly independently of the spot at which the depression force is introduced on the actuating element. The downward displacement of the operating panel thus takes place under parallel guidance of this operating panel. Tilting is substantially suppressed.

An advantage of the above-described parallel guidance of the operating panel is that the sensor system, which detects an actuation, which is to say a manual stroke movement of the actuating element, can have a simpler design and, in case of doubt, can also respond to tilting, However, since such tilting is substantially suppressed, this sensor system sensitive to tilting is “immune” in this regard. Ideally, only a single travel or force sensor is required for the entire actuating element. This considerably reduces the hardware complexity of the design of the operating unit according to the invention.

In an advantageous further development of the invention, it may be provided that the bearing device comprises at least two first leaf spring pairs, which are oriented parallel to one another, wherein the at least one second leaf spring pair is oriented at an angle different from 0° with respect to each of the first leaf spring pairs, and in particular perpendicularly to each of the first leaf spring pairs. In this refinement of the invention, two first leaf spring pairs are thus present, which are oriented parallel to one another, wherein the at least one second leaf spring pair provided according to the invention is disposed at an angle dissimilar from 0° with respect to the first leaf spring pairs, and in particular is oriented perpendicularly thereto.

As an alternative to the above-described embodiment of the invention, however, it may also be provided that the bearing device comprises at least two second leaf spring pairs, which are disposed parallel to one another, wherein each of the second leaf spring pairs is oriented at an in particular identical angle, different from 0°, with respect to at least one first leaf spring pair, and in particular perpendicularly to the at least one first leaf spring pair.

In this variant, two second leaf spring pairs are thus present, which are oriented parallel among one another, wherein the first leaf spring pair runs at an angle dissimilar from 0° with respect to the two second leaf spring pairs, and in particular is oriented perpendicularly thereto.

A further expedient variant of the invention provides that the bearing device comprises at least two first and at least two second leaf spring pairs, wherein the first leaf spring pairs are disposed parallel among one another and the second leaf spring pairs are disposed parallel among one another, and wherein the first leaf spring pairs are oriented at an angle different from 0° with respect to, and in particular perpendicularly to the second leaf spring pairs.

In general, operating units of the kind in question here are equipped with rectangular actuating elements, or with actuating elements that have a substantially rectangular operating panel. The actuating element, or the operating panel thereof, thus includes four edge sections that preferably are substantially rectilinear and located opposite one another in pairs. It is now expedient when the bearing device comprises two first and two second leaf spring pairs, wherein a respective leaf spring pair is disposed on each of the four edge sections in such a way that the leaf springs thereof run parallel, or substantially parallel, which is to say as an extension of the respective edge section.

It may be provided in a further advantageous embodiment of the invention that a first leaf spring pair and a second leaf spring pair are designed as an integral angular leaf spring pair comprising two leaf springs that extend at an angle, and in particular at a right angle, with respect to one another. In this variant, a first leaf spring pair and a second leaf spring pair have an integral design in each case, which reduces the assembly complexity. The respective leaf springs, disposed on top of one another, of the first and second pairs are oriented at an angle, and in particular at a right angle, with respect to one another, viewed in pairs. Such angular leaf spring pairs can advantageously be disposed in two diagonally opposed corner regions of a substantially rectangular actuating element or actuating element comprising a substantially rectangular operating panel.

In the above-described embodiment of the invention, which is to say with the use of angular leaf spring pairs, it may also be advantageous if each angular leaf spring includes two legs, wherein each leg has a free end and a connections end that is integrally joined to the respective other leg, and wherein either the free ends of the legs are directly or indirectly joined to the actuating element, and the connecting ends of the legs are directly or indirectly joined to the retaining device, or vice versa.

As was already mentioned above, the leaf springs of each leaf spring pair are held at a distance by spacer elements. If angular leaf springs are used, preferably three such spacer elements are present per angular leaf spring pair, and more particularly one spacer element at each of the free ends of the two legs of the angular leaf springs, and a further spacer element between the connecting ends of the two angular leaf springs.

In a further advantageous embodiment of the invention, the operating unit is furthermore provided with an actuator for forcibly moving the actuating element when a minimum actuating force or a minimum actuating stroke is sensed. The minimum force introduction or the minimum movement stroke is sensed by way of a sensor, which in this case can also form part of the operating unit according to the invention, and is forwarded to an activation and evaluation unit. This, in turn, activates a mechanical actuator, which is designed in the form of a transverse armature solenoid, for example. The armature is attracted once, which may result in an increase in the stroke movement of the actuating element or in a transverse moment (on a limited scope). However, the actuator can also be used to carry out vibration movements of the actuating element, serving as tactile feedback of the successful actuation thereof. Finally, it is possible for further feedback in acoustic or visual form, for example, to take place.

The invention will be described in more detail hereafter based on two exemplary embodiments and the drawing. In the drawing in detail:

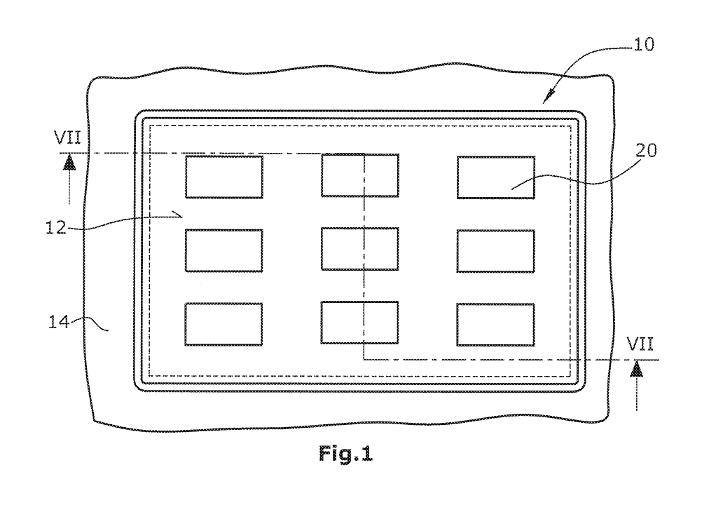

FIG. 1 shows a top view onto the operating panel of a depressible, elastically mounted actuating element, comprising nine actuating or control/symbol fields in the present exemplary embodiment;

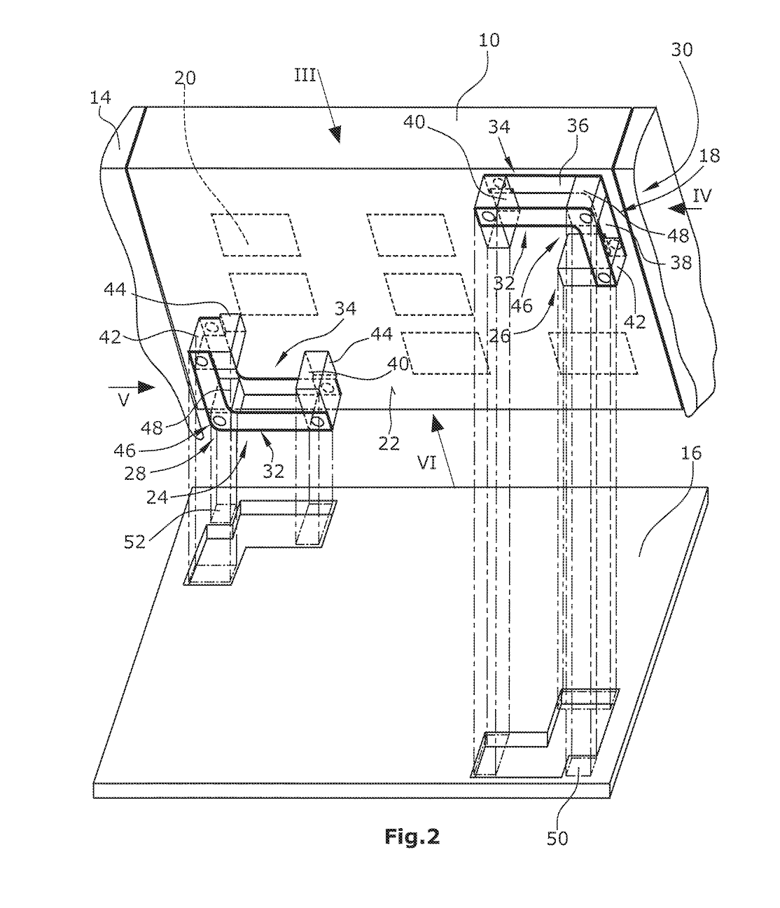

FIG. 2 shows a perspective view of the bottom side of the actuating element according to FIG. 1;

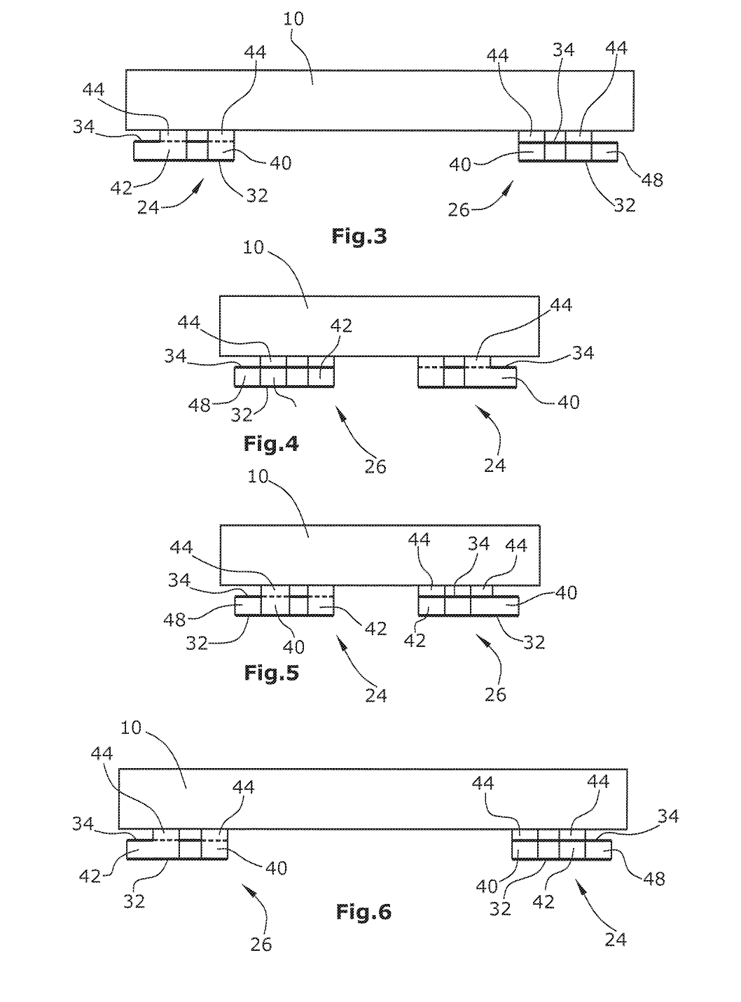

FIGS. 3 to 6 show side views corresponding to arrows III to VI from FIG. 2 of the actuating element, comprising leaf spring bearing elements disposed therebeneath;

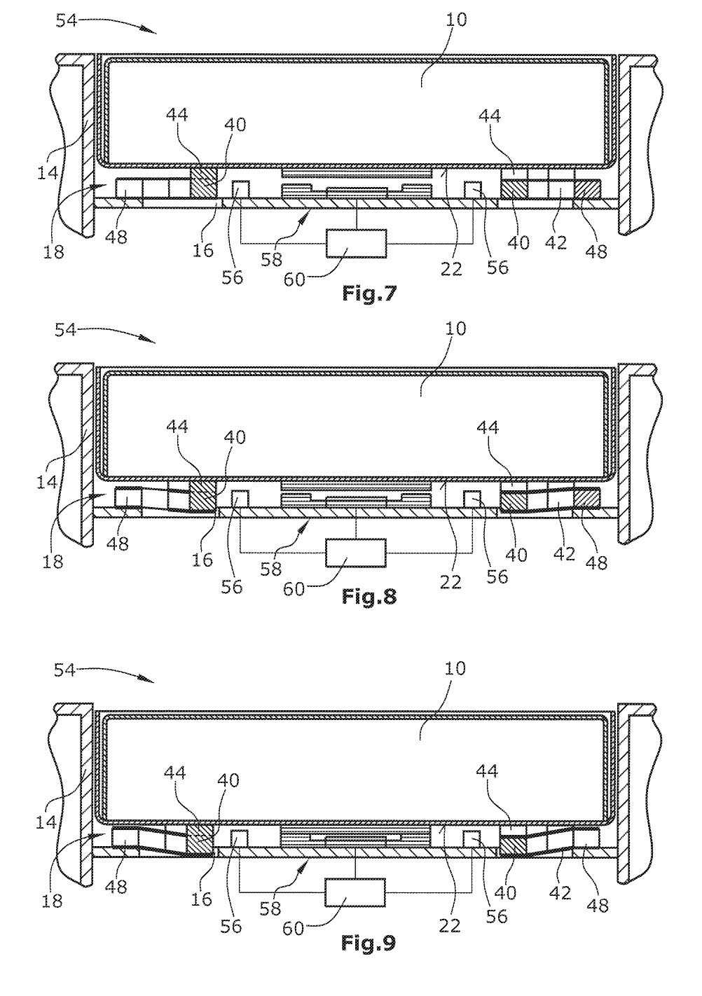

FIG. 7 shows a sectional view through a housing comprising an actuating element elastically mounted therein according to FIGS. 1 to 6 in the initial state, which is to say without force introduction on the actuating element;

FIG. 8 shows a sectional view similar to that according to FIG. 7, however upon manual actuation of the actuating element, whereby the actuation thereof is detected by a sensor system;

FIG. 9 shows a sectional view similar to that according to FIGS. 7 and 8, however after activation of an actuator, for example for further movement of the actuating element in the depression direction, serving as haptic tactile feedback of the actuating element;

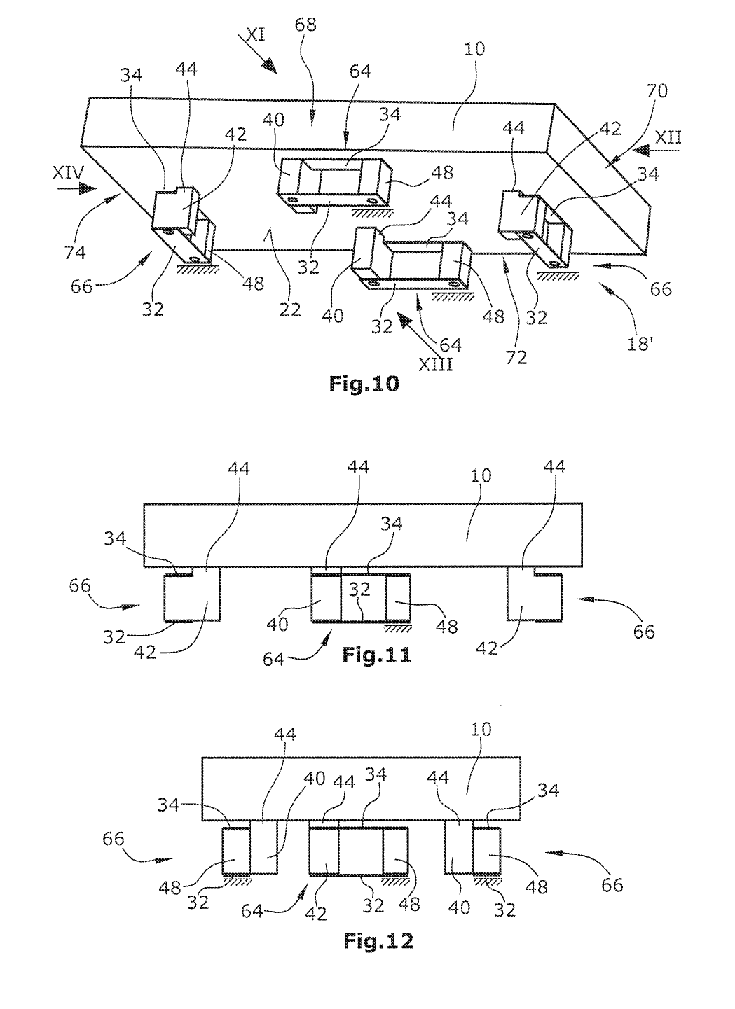

FIG. 10 shows a bottom view of an actuating element similar to that shown in a top view in FIG. 1, however with alternatively designed leaf spring bearing elements; and

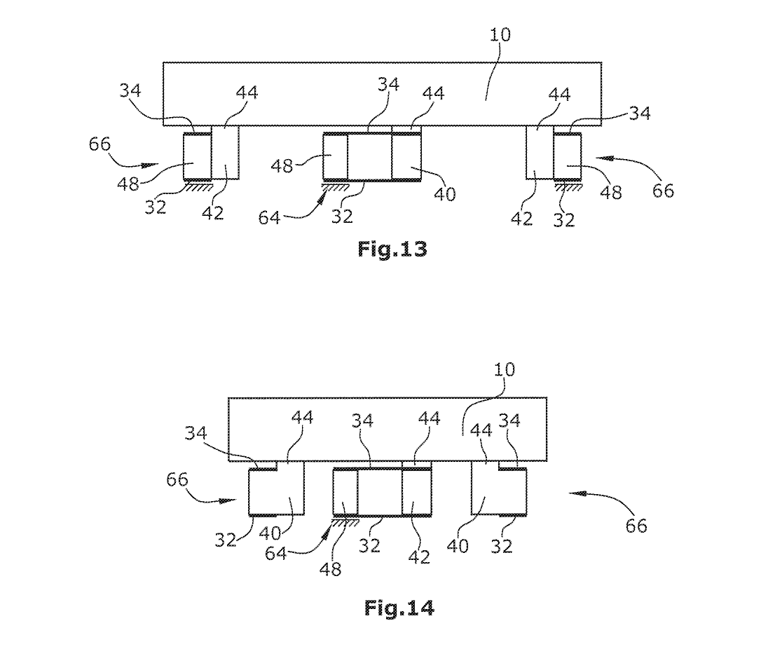

FIGS. 11 to 14 show side views of the actuating element in the direction of arrows XI to XIV according to FIG. 10, including the leaf spring bearing elements disposed on the bottom sides.

FIGS. 1 to 6 show the design and elastic mounting of an actuating element 10 comprising an operating panel 12, which maintains the orientation thereof, which is to say undergoes parallel displacement, when the actuating element 10 is depressed. This actuating element 10, as shown in FIG. 7, is installed inside a housing 14, which comprises a retaining device 16, for example in the form of a board, on which the actuating element 10 is elastically and depressibly mounted by way of a bearing device 18.

According to FIG. 1, the operating panel 12 includes multiple (nine, in the exemplary embodiment) control or symbol fields 20. The bearing device 18, which elastically joins the actuating element 10 to the retaining device 16, is disposed on the bottom side 22 of the actuating element 10 which faces away from the operating panel 12. For this purpose, the bearing device 18 in the exemplary embodiment according to FIGS. 1 to 9 comprises two angular leaf spring pairs 24, 26, which are disposed in two diagonally opposed corner regions 28, 30 of the bottom side 22 of the actuating element 10. Each angular leaf spring pair 24, 26 comprises two leaf springs 32, 34, which in this exemplary embodiment are rectangular and each have two legs 36, 38. A spacer element 40, 42, which holds the respective leg ends at a distance and moreover is joined to the bottom side 22 of the actuating element 10, is located at the free ends of each of the parallel legs 36, 38 that are disposed on top of one another. For this purpose, the spacer elements 40, 42 each extend beyond the respective upper angular leaf spring 34 in a region located next to the legs 36, 38, resulting in an offset 44.

A further spacer element 48 is likewise provided in the corner regions or at the connecting ends 46 of the leg pairs 36, 38 of the angular leaf springs 32, 34. FIG. 2 at reference numerals 50, 52 indicates that the angular leaf spring pairs 24, 26 are mounted on the retaining device 16 in these corner regions 28, 30, which is to say in the region of the connecting ends 46.

The connection of the angular leaf spring pairs 24, 26 to the bottom side 22 of the actuating element 10, and the mounting thereof on the retaining device 16, are illustrated in greater detail in the side views shown in FIGS. 3 to 6.

FIGS. 7 to 9 show different situations over the course of the actuation of the actuating element 10 when this is installed in an operating unit 54, The operating unit 54 comprises the housing 14, the retaining device 16, as well as the bearing device 18. In addition, the operating unit is also provided with two distance or force sensors 56 in this exemplary embodiment, which based on the path traveled by the actuating element 10 upon the actuation thereof identify that a minimum actuating force has been applied to the actuating element 10 for the desired triggering of a function. In addition, the operating unit 54 comprises an actuator 58, which is designed as a transverse armature solenoid in this exemplary embodiment. The sensors 56 and the actuator 58 are connected to one another via an evaluation and activation unit 60.

FIG. 7 shows the situation in which the actuating element 10 has not yet been actuated (idle position). FIG. 8 shows that an actuating force has been introduced into the operating panel 12, for example at the position of the force introduction arrow 62, The actuating element 10 is displaced downwardly, while the orientation of the operating panel 12 is maintained, which is to say while this operating panel 12 undergoes parallel displacement. The angular leaf spring pairs, which is to say, in this exemplary embodiment, the four leaf spring pairs 64, 66, which are oriented parallel to one another in pairs, ensure that the orientation of the operating panel 12 is maintained, wherein the two first leaf spring pairs 64 oriented parallel to one another are oriented transversely with respect to the second leaf spring pairs 66.

FIGS. 10 to 14 show an alternative exemplary embodiment of the bearing device 18 according to the exemplary embodiment according to FIGS. 1 to 9. The corresponding bearing device is denoted by reference numeral 18′ in FIG. 10. To the extent that the elements shown in FIGS. 10 to 14 correspond (which is to say are identical and/or functionally equivalent) to those of the exemplary embodiment according to FIGS. 1 to 9, they are denoted by the same reference numeral.

In the exemplary embodiment according to FIGS. 10 to 14, four leaf spring pairs 64, 66 are provided, which are designed and disposed separately from one another and each comprise two leaf springs 36 and 38. The four leaf spring pairs 64, 66 are distributed among the four edge regions 68, 70, 72, 74 of the actuating element 10 on the bottom side 22 thereof. In FIGS. 10 to 14, in turn, it is shown at reference numeral 50 where the leaf spring pairs are mounted on the retaining device 16. In these figures, in turn, reference numeral 44 shows where the leaf spring pairs 64, 66 are connected to the bottom side 22 of the actuating element 10.

### LIST OF REFERENCE NUMERALS

10 actuating element

12 operating panel of the actuating element

14 housing

16 retaining device

18 bearing device for the actuating element

18′ bearing device for the actuating element

20 symbol fields on the operating panel

22 bottom side of the actuating element

24 angular leaf spring pair

26 angular leaf spring pair

28 corner region of the actuating element

30 corner region of the actuating element

32 angular leaf spring

34 angular leaf spring

36 leg of the angular leaf spring

38 leg of the angular leaf spring

40 spacer element of the (angular) leaf spring pairs

42 spacer element of the (angular) leaf spring pairs

44 fixation of the leaf spring pairs to the operating element

46 connecting ends of the legs

48 spacer element of the (angular) leaf spring pairs

50 connection of angular leaf pair to retaining device

52 connection of angular leaf pair to retaining device

54 operating unit

56 force or travel sensor

58 actuator

60 evaluation and activation unit

62 force introduction point

64 leaf spring pair

66 leaf spring pair

68 edge region of the actuating element

70 edge region of the actuating element

72 edge region of the actuating element

74 edge region of the actuating element

1-10. (canceled)

11. An operating unit for a vehicle component, in particular for a heating, ventilation and/or air conditioning system, comprising:
a manually actuatable actuating element;
a retaining device for retaining the actuating element; and
a bearing device for elastically mounting the actuating element on the retaining device,
wherein the bearing device comprises at least one first leaf spring pair, including two leaf springs that are disposed on top of and spaced apart from one another and extend parallel to one another, each having a first end and a second end located opposite therefrom, wherein the first and second ends of the leaf springs are each rigidly joined to one another by a spacer element, and wherein the at least one first leaf spring pair, at the first ends of the leaf springs thereof, is directly or indirectly rigidly joined to the actuating element, and at the second ends of the leaf springs thereof, is directly or indirectly rigidly joined to the retaining device, wherein
the bearing device comprises at least one second pair of leaf springs between the actuating element and the retaining device, and
the at least one second leaf spring pair is oriented at an angle different from 0° with respect to the at least one first leaf spring pair, and in particular perpendicularly to the at least one first leaf spring pair.

12. The operating unit according to claim 11, wherein the bearing device comprises at least two first leaf spring pairs, which are oriented parallel to one another, wherein the at least one second leaf spring pair is oriented at an angle different from 0° with respect to each of the first leaf spring pairs, and in particular perpendicularly to each of the first leaf spring pairs.

13. The operating unit according to claim 11, wherein the bearing device comprises at least two second leaf spring pairs, which are disposed parallel to one another, wherein each of the second leaf spring pairs is oriented at an in particular identical angle, different from 0°, with respect to the at least one first leaf spring pair, and in particular perpendicularly to the at least one first leaf spring pair.

14. The operating unit according to claim 11, wherein the bearing device comprises at least two first and at least two second leaf spring pairs, wherein the first leaf spring pairs are disposed parallel among one another and the second leaf spring pairs are disposed parallel among one another, and wherein the first leaf spring pairs are oriented at an angle different from 0° with respect to, and in particular perpendicularly to the second leaf spring pairs.

15. The operating unit according to claim 14, wherein the actuating element is designed in a rectangular manner, including four edge sections that are substantially rectilinear and located opposite one another in pairs, and at least two first and at least two second leaf spring pairs are disposed along each of the four edges of the actuating element.

16. The operating unit according to claim 11, wherein the two ends of the leaf springs of each leaf spring pair, which are disposed on top of one another, are held at a distance by the spacer elements.

17. The operating unit according to claim 14, wherein a first and a second leaf spring pair are designed as an integral angular leaf spring pair comprising two leaf springs that extend at an angle, and in particular at a right angle, with respect to one another.

18. The operating unit according to claim 16, wherein each angular leaf spring includes two legs, each leg has a free end and a connecting end integrally joined to the respective other leg, and either the free ends of the legs are directly or indirectly joined to the actuating element, and the connecting ends of the legs are directly or indirectly joined to the retaining device, or vice versa.

19. The operating unit according to claim 18, wherein the free ends of the legs are held at a distance by a respective spacer element, and the connecting ends of the legs are held at a distance by a further spacer element.

20. The operating unit according to claim 15, wherein a respective angular leaf spring pair is disposed at least in each of two diagonally opposed corner regions of the actuating element.

21. The operating unit according to claim 17, wherein each angular leaf spring includes two legs, each leg has a free end and a connecting end integrally joined to the respective other leg, and either the free ends of the legs are directly or indirectly joined to the actuating element, and the connecting ends of the legs are directly or indirectly joined to the retaining device, or vice versa.
